(19) United States
(12) Patent Application Publication
(10) Pub. No.: US 2009/0301633 A1
(43) Pub. Date: Dec. 10, 2009

(54) TAMPER RESISTANT LABEL FOR DETECTING DEVICE OPENINGS

(75) Inventors: Scott Andrew MYERS, San Francisco, CA (US); Erik WANG, Redwood City, CA (US)

Correspondence Address: BEYER LAW GROUP LLP/APPLE INC., P.O. BOX 1687, CUPERTINO, CA, 95015-1687, US

(73) Assignee: Apple Inc., Cupertino, CA (US)

(21) Appl. No.: 12/185,037

(22) Filed: Aug. 1, 2008

Related U.S. Application Data
(60) Provisional application No. 61/059,756, filed on Jun. 7, 2008.

(51) Int. Cl. B29C 65/50; B32B 27/10; B32B 27/36

(52) U.S. Cl. 156/64; 428/343; 428/344; 428/34.2; 428/35.7

(57) ABSTRACT

A tamper resistant label adapted to indicate whether a device has been opened is disclosed. The label can be flat and flexible, having a first distal end with an adhesive substance on its top side and a second distal end having an adhesive substance on its bottom side. The first distal end can be affixed to a first object, while the second distal end can be affixed to a second object separate from the first object, with the first and second objects then being coupled together to form a single device. The adhesives can render the label difficult to remove. A middle portion between the first and second distal ends can include one or more directional changes therein such that the entire label does not lie in a straight line. A substantial opening of the single device can then tear or damage the label, indicating that an opening has occurred.

### CROSS REFERENCE TO RELATED APPLICATIONS

This application claims priority to U.S. Provisional Patent Application No. 61/059,756, filed Jun. 7, 2008, which is incorporated herein by reference in its entirety and for all purposes.

### TECHNICAL FIELD

The present invention relates generally to the detection of tampering attempts, and more particularly to the use of physical features to detect when an electrical or electronic device has been opened.

### BACKGROUND

Media players, cellular telephones and numerous other electrical or electronic devices and appliances are now ubiquitous. Such devices often require repairs, upgrades or other servicing by the manufacturer or provider, and it is often discouraged or even prohibited for an ordinary consumer or other unauthorized user to open the device. Unfortunately, many users nevertheless open their electronic devices to attempt to repair, reverse engineer or even hack various things within the device. Of course, one drawback to such unauthorized access is that one or more internal items may be destroyed or compromised, thus limiting the ability of the manufacturer or provider to provide effective servicing of the device.

As is generally well known, the unauthorized opening or accessing of some electronic devices can be a condition that voids any warranty or guarantee concerning that device. As such, it is often in the interests of a manufacturer or provider to be able to know when such a device has been compromised. Such knowledge can aid the manufacturer or provider in being able to provide effective repairs or servicing of an electronic or other personal device that has been compromised, and may allow for the voiding of any warranty, where appropriate. This ability can save manufacturers and providers substantial costs when they are not forced to repair or service devices that are under warranty but that have been tampered with by hackers or unsophisticated users.

Unfortunately, it is not always easy to determine whether an electrical or electronic device has been opened by a user. Many such devices are simply held together by screws or other simple fasteners, such that users can readily take the devices apart and put them back together, with no way of anyone knowing that such activities have taken place. While there are various ways of constructing such devices so as to render it impossible to open the device without affecting some condition, such as by providing an outer seal, for example, many such techniques involve adding something that is obvious to any user of the device who wishes to open it.

While many designs for electronic and personal devices have generally worked well in the past, there is always a desire to provide new and improved designs or techniques that can make it easier for a manufacturer or provider to determine whether such devices have been previously opened (i.e., “device openings”), so as to alert for the possibility of tampering with the internal components of the device.

### SUMMARY

It is an advantage of the present invention to provide physical features that allow for detecting when an electrical, electronic or other device has been opened. This can be accomplished at least in part through the use of a specialized label that is attached to multiple locations inside the device, such that the label is ripped, damaged or otherwise affected in a detectable manner when the device is opened.

In various embodiments, the invention can include a flat and flexible label adapted for detecting whether or not a device has been opened. This label can include a first distal end having an adhesive substance affixed to a top side thereof and adapted to be affixed to the surface of a first object, a second distal end having an adhesive substance affixed to a bottom side thereof and adapted to be affixed to the surface of a second object separate from the first object, and a middle portion between the first and second distal ends, said middle portion having one or more directional changes therein such that the entire label does not lie in a straight line. The first and second objects can be adapted to be coupled together to form a single assembled device. Further, each of the first distal end, second distal end and middle portion can be substantially flat and lie substantially within a single plane. The middle portion of the label can be U-shaped in nature, which U-shape does not have any adhesive.

The label can be arranged and affixed such that the label rips, tears or is otherwise damaged to a point that it cannot be repaired when the device is fully or at least substantially opened. The single device can become substantially opened when the first object is tilted with respect to the second object at more than a certain angle, such as an angle that is greater than about 10 degrees or greater than about 40 degrees. Alternatively, the single device can become substantially opened when the first object and second object are separated more than about one inch apart at any location where the first object and second object touch to form the single device. Such a rip or damaging of the label can then be readily noticed by an authorized technician or representative when the entire device is turned in for official servicing or repairs. In some embodiments, the label can remain intact when the device is only partially opened or “cracked open,” such that it is possible to peek inside the device without damaging the label.

In various embodiments, a generally U-shaped label can be used, although alternative shapes can also be effective and used instead. Such alternative shapes can include a zigzag shape or any other shape that allows for some extension, such that a slight opening of the device does not damage the label. The label can be formed from one or more materials, such as paper, plastic and/or a metallic foil, among other suitable materials, while the adhesive substance can be formed from glue, cement, paste and/or double-sided tape among other suitable materials.

In various further embodiments, an electronic device is provided that can include a first housing component containing one or more internal components, a second housing component, and a flat and flexible label that can be any of the labels which are provided above, such as a U-shaped label. The first and second housing components can be adapted to be coupled together to form the electronic device, and the flat and flexible label can be affixed to internal surfaces that are associated with each of the first and second housing components.

In still further embodiments, a method of detecting whether an electronic device has been opened is provided. The method can include the steps of forming a first portion of an electronic device, forming a second portion of the electronic device, attaching a flat and flexible label to each of the first and second portions such that a substantial separation of said first and second portions from each other results in the label becoming damaged, combining the first and second portions to form the overall electronic device, opening said electronic device a small amount, and determining whether the label is damaged. Similar to the foregoing embodiments, the flat and flexible label can be located entirely within the electronic device, and the opening of the device can be an amount that would be insufficient to damage the label. The label can be any of the labels which are provided above, such as a U-shaped label. Also, the attaching step can include attaching the adhesive side of one distal end of the label to the first portion of the electronic device and attaching the adhesive side of a second distal end of the label to the second portion of the electronic device.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive apparatus and method for providing physical features to detect when an electrical or electronic device has been opened. These drawings in no way limit any changes in form and detail that may be made to the invention by one skilled in the art without departing from the spirit and scope of the invention.

FIG. 1 illustrates in side perspective and partially exploded view an exemplary electronic device having an upper portion, lower portion, and a specialized U-label adapted to indicate when the device has been opened according to one embodiment of the present invention.

FIG. 2 illustrates in bottom perspective view the upper portion of the electronic device of FIG. 1 having the specialized U-label affixed thereto according to one embodiment of the present invention.

FIG. 3 illustrates in side perspective view the lower portion of the electronic device of FIG. 1 having the specialized U-label affixed thereto according to one embodiment of the present invention.

FIG. 4 illustrates in side perspective view the lower portion of the electronic device of FIGS. 1 and 3 having the specialized U-label affixed thereto and flexed upward according to one embodiment of the present invention.

FIG. 5 illustrates in front perspective view the electronic device of FIG. 1 assembled but cracked open according to one embodiment of the present invention.

FIG. 6 illustrates in side elevation view the electronic device of FIG. 1 as assembled but cracked open according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The invention relates in various embodiments to the implementation and use of one or more physical features to detect whether an electrical or electronic device has been opened, such as by an unauthorized user. Such a device can be, for example, an electronic device, such as an iPod® media player or iPhone® cellular telephone made by Apple Inc., or any other similar device. The physical feature or features can include, for example, one or more tamper resistant labels, that can be assembled into the interior of the device in a manner such that the physical features become torn, damaged or otherwise changed when the device is substantially opened.

In various embodiments of the present invention, a tamper resistant label adapted to be affixed inside an electrical or electronic device is provided. The tamper resistant label can be adapted such that different portions are affixed to different internal components of the device. In this manner, fully or at least substantially opening the device will cause the label to rip, tear or otherwise become damaged. The overall result is that authorized personnel will be more able to detect when the device has been previously opened.

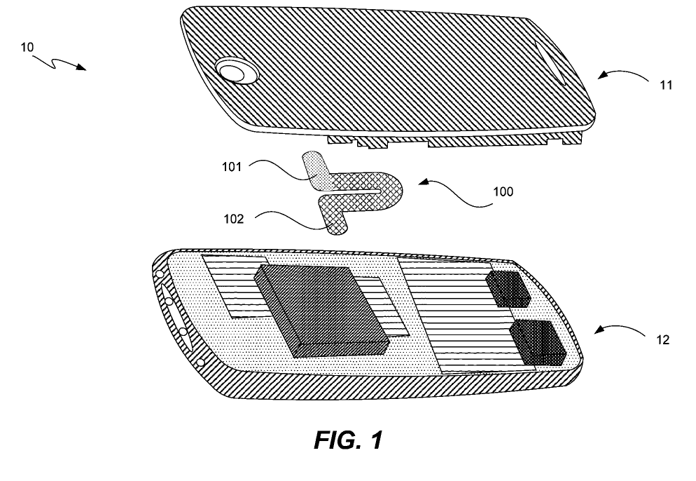

Referring first to FIG. 1, an exemplary electronic device having an upper portion, lower portion, and a specialized U-label adapted to indicate when the device has been opened according to one embodiment of the present invention is shown in side perspective and partially exploded view. Such components can generally be included with an upper half or “tilt” portion or object 11 and a lower half or “housing” portion or object 12. As will be readily appreciated, this particular terminology does not alter the fact that both the upper and lower portions can have associated housing components. One or both housing components can be said to effectively “contain” or hold one or more internal components, and both are specifically adapted to be combined to form the overall electronic device. In addition, it is similarly not required that the upper or lower portions actually be half of the overall electronic device, such that other portion sizes are possible.

A specialized U-label 100 can be arranged such that it is affixed to an associated surface or thing on both of the upper portion 11 and lower portion 12 of cellular telephone 10. U-label 100 can have two distal ends, with end 101 being adapted to affix to the upper portion 11 and end 102 being adapted to affix to the lower portion 12 of cellular telephone 10. Due to the arrangement illustrated here, it may be preferable to attach one side of the U-label to the associated surface or object on the upper portion, and to attach the obverse side of the U-label to the associated surface or object on the lower portion of the cellular telephone.

As will be readily appreciated, U-label 100 can come in a wide variety of shapes and sizes, and such an item does not necessarily need to have a U-shape to be effective. For example, a zigzag or other arrangement can be effective as well. Other shapes and sizes of the tamper resistant label that can be effective for the purposes disclosed herein will become apparent to those skilled in the art, and the use of all such shapes and sizes are specifically contemplated for use herein. The U-label or other appropriately shaped label can be flat, thin, flexible and/or tear-resistant in nature, and preferably has all of these qualities. Such a label can be formed from a variety of materials, such as paper, plastic, or a thin metallic foil, among other suitable materials. As one particular example, a Mylar or other PET film having a thickness of about 0.15 millimeters is known to work well for such a label.

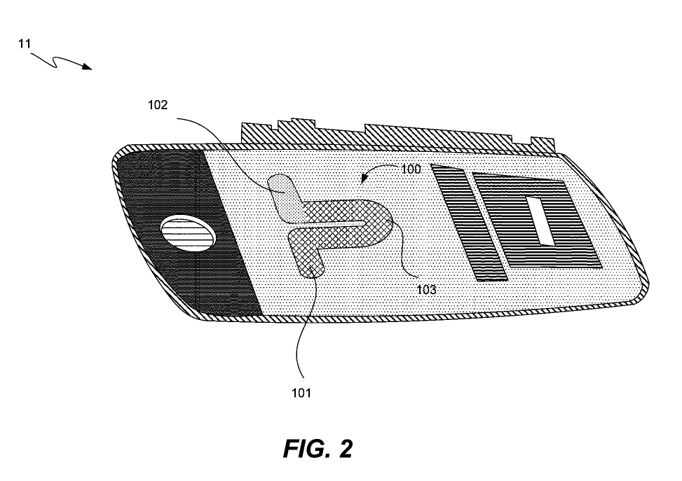

Turning next to FIG. 2, the upper portion of the electronic device of FIG. 1 having the specialized U-label affixed thereto is illustrated in bottom perspective view according to one embodiment of the present invention. As shown, an adhesive on the top surface of distal end 101 is used to affix that end to an associated surface or object within the top portion 11 of the overall electronic device. As can be seen, the other distal end 102 has an adhesive on its bottom surface such that this surface can be attached to the bottom portion (not shown) of the overall electronic device. A wide variety of suitable adhesives can be used for this purpose, such as, for example, any appropriate glue, cement, paste and/or double-sided tape, among others. Such an adhesive can be specifically formulated to leave behind a strong residue when removed, such that a complete removal of the label and all traces of adhesive from the device surfaces is difficult or impossible. In this manner, an unauthorized user is not easily able to remove the label and replace it with a new or alternative copycat label without such a ploy being detectable by authorized personnel when the device is opened at a later time.

A middle portion 103 of U-label 100 is preferably situated between the end portions 101, 102, and this middle portion preferably has no adhesive anywhere on either side. This middle portion 103 is preferably adapted such that the label can be flexed or extended a short distance without tearing or becoming damaged when the electronic device is opened only a small amount. As noted above, the U-shape illustrated herein is one good example of such a middle portion, although zigzag shapes and other alternative shapes are certainly possible. Such alternative shapes ideally allow for some flexing of a middle portion of the label to allow for the electronic device to open a small amount without the label becoming torn or damaged, but not so much that the device can be opened a substantial amount without such tearing or damaging of the label taking place.

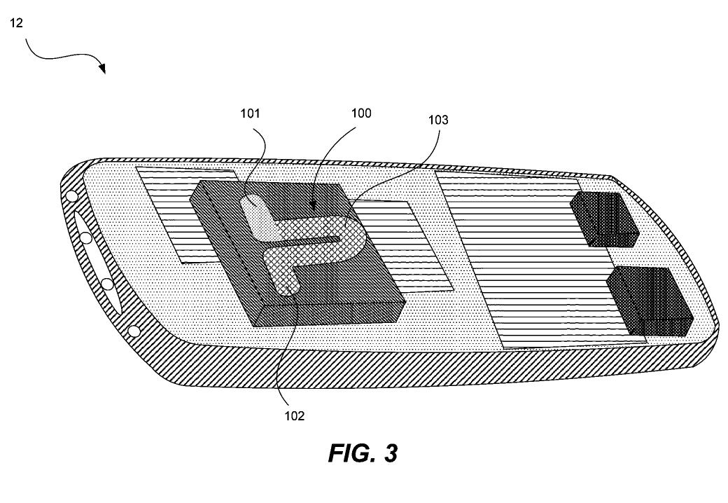

FIG. 3 illustrates in side perspective view the lower portion of the electronic device of FIG. 1 having the specialized U-label affixed thereto according to one embodiment of the present invention. Similar to that which is shown in FIG. 2 above, an adhesive on the bottom surface of distal end 102 is used to affix that end to a component within the bottom portion 12 of the overall electronic device. As can be seen, the other distal end 101 has an adhesive on its bottom surface such that this surface can be attached to the upper portion (not shown) of the overall electronic device. Again, middle portion 103 between the end portions 101, 102 preferably has no adhesive anywhere on either side.

Again, the label can be arranged and affixed such that the label rips, tears or is otherwise damaged to a point that it cannot be repaired when the overall electronic device is fully or at least substantially opened. For purposes of the discussion herein, the electronic device can become substantially opened when one portion (e.g., the top portion) is tilted with respect to the other portion at more than a certain angle, such as an angle that is greater than about 10 degrees or greater than about 40 degrees, depending on the design parameters desired by the manufacturer or creator. Alternatively, the electronic device can become substantially opened when the first object and second object are separated more than about one inch apart at any location where the top portion and bottom portion touch to form the single overall electronic device. Such a rip or damaging of the label can then be readily noticed by an authorized technician or representative when the entire device is turned in for official servicing or repairs. In some embodiments, the label can remain intact when the device is only partially opened or “cracked open,” such that it is possible to peek inside the device without damaging the label.

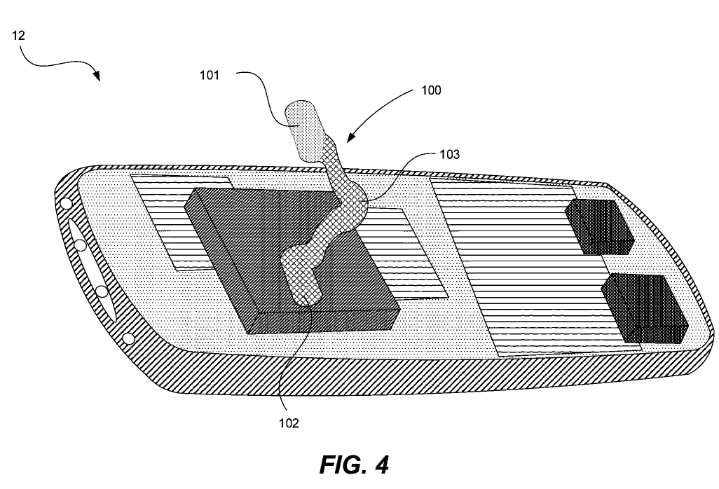

FIG. 4 is substantially similar to FIG. 3, only having the specialized U-label affixed to the bottom portion of the electronic device and flexed upward according to one embodiment of the present invention. This figure is shown without the upper portion of the electronic device for purposes of illustration. As can be seen, when only the bottom portion 12 and U-label 100 are used, distal end 102 of the U-label is affixed to some component within or on the bottom portion 12, and the rest of the U-label can flex upward when end 101 is lifted. Although U-label is preferably formed from a flat and flexible but fragile material, a significant upward distance can be achieved between distal ends 101 and 102 when flexing the label without actually damaging the label. In some embodiments, if specialized U-label 100 is flexed upward any further than what is shown in FIG. 4, then the label will rip or otherwise become irreversibly damaged. Such ripping or damaging can occur in one or more locations, such as at the center of middle portion 103.

In various embodiments, the specialized label 100 can be formed from a thin paper or polymer adapted to flex as shown. The adhesive used on the distal ends 101, 102 of the label can be a specialized cement adhesive that is not readily detached or undone once an affixing is accomplished. Preferably, once these ends 101, 102 are affixed to their respective components within the electronic device, the ends cannot be easily detached from such components without leaving tell-tale residue and portions behind. This aids in the ability to provide ready detection of when the overall device has been opened such that possible tampering may have occurred.

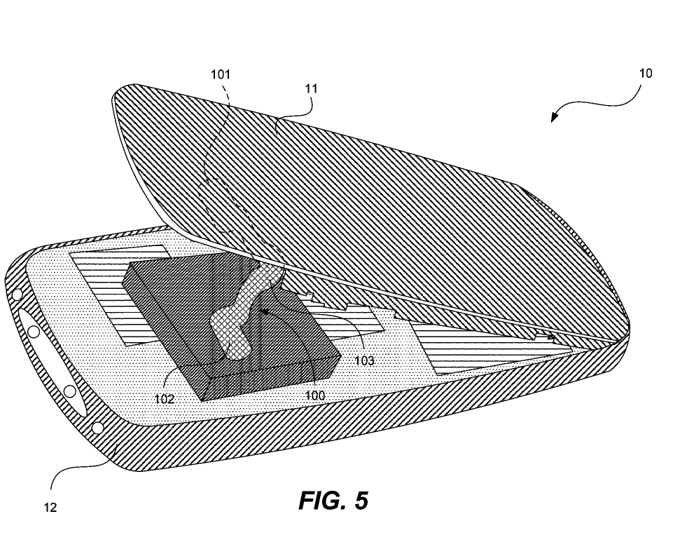

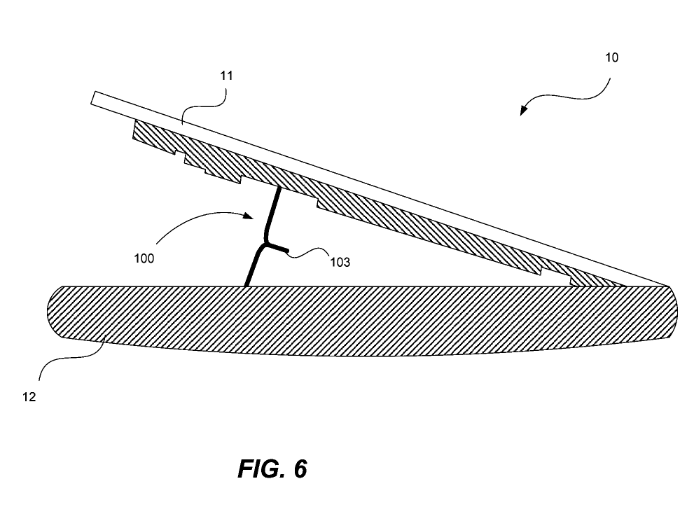

Continuing now to FIGS. 5 and 6, the electronic device of FIG. 1 as assembled but cracked open is shown in front perspective and side elevation views respectively. As shown, electronic device 10 as arranged represents the furthest that the tilt portion 11 can be raised upward and away from the housing portion 12 without damaging the specialized U-label 100 that is affixed to both. Any further raising of the tilt portion or upper portion 11 away from the housing or lower portion 12 will result in at least a partial tear or damaging of the U-label, which tear or damage will be noticeable the next time that the device 10 is put into this same position as shown in FIGS. 5 and 6. Such a distance between the device halves can be achieved by tilting the upper portion 11 of the device with respect to the lower portion 12, as shown. The tilt can raise the device such that the angle between the halves is about ten to about forty degrees, with any further tilt resulting in label tear or damage. As will be readily appreciated, other distances and angles are also possible, and the respective specialized label can be designed and attached to accommodate for such distances.

Although the middle portion 103 can be U-shaped, as shown, this specialized label can take on any of a wide variety of shapes that serve to effectively provide distance between its two ends 101, 102. Such designs may effectively involve any number of directional changes and distances within the middle portion, such that an effective cracking open of the device to check whether the label has been damaged is possible. All such variable and potential label features and designs to serve this purpose are contemplated for use with the present invention.

Various embodiments of the present invention include a method of detecting whether an electronic device has been opened. Such methods can include forming or assembling the electronic device, which can include the steps of forming a first portion of the electronic device and forming a second portion of the electronic device. A flat and flexible label can then be affixed, attached or otherwise coupled to each of these first and second portions, such that a full or substantial separation of the first and second portions from each other results in the label becoming damaged. This label can be the U-label described in greater detail above, or can be a similar label having any of a variety of suitable shapes, sizes and materials, as will be readily appreciated. A substantial separation or opening of the electronic device is discussed in greater detail above. The method can also include combining these first and second portions to form the electronic device, such that the flat and flexible label is located entirely within the electronic device. The formation of the device in this manner then permits for the detection of whether or not the device has been opened by someone else at a later time.

With respect to the attaching step, the adhesive side of one distal end can be affixed, attached or otherwise coupled to the first portion or any item associated with the first portion of the electronic device, while the adhesive side of the other distal end can be affixed, attached or otherwise coupled to the second portion or any item associated with the second portion of the electronic device.

The electronic device can then be sold, leased or otherwise provided to a user for regular use, which user is not ordinarily permitted to open or access one or more internal regions of the electronic device. In the event that the user nevertheless does fully or substantially open the electronic device, then the label tears or otherwise becomes damaged. Although such damage may be noticed by the user after opening the device, any repair or replacement of the torn or damaged label would ordinarily be difficult after the fact. In the event that the electronic device is ever exchanged, returned for repairs or otherwise provided back to the manufacturer or other authorized party, then the device can be checked to see if it has ever been opened since its initial issuance.

Such a check can involve opening the electronic device a small amount that would be insufficient to damage the label, and then determining whether the label is indeed damaged or torn. Such a determination can be made, for example, by way of a visual inspection by authorized personnel. In the event that the device has not been fully or substantially opened previously, then the U-label or other appropriate label will remain intact, and the electronic device and label will appear as shown in FIGS. 5 and 6 when the device is opened a small amount. However, if the device has been substantially opened previously, then the label should have become torn or damaged, such that the label does not flex as shown in FIGS. 5 and 6, and/or will exhibit some tear, partial tear and/or deformation thereon. Furthermore, should the label appear to be unmolested, as shown in FIGS. 5 and 6, the inspecting personnel can then full open the device (thus tearing the label) to inspect whether there is any residue or other evidence of tampering with the label.

In the event that no visible tampering has taken place, the remains of the first label can be removed as best as possible by authorized personnel. A new label can then be assembled into the device once it is ready to be put back together, and a suitable notation can be made with respect to an authorized device opening having taken place. Such a notation can be made with respect to an outside record that correlates to an owner and/or serial number of the electronic device. Alternatively, or in addition, some kind of proprietary or specialized marking can be made within the device by the authorized personnel to indicate that the previous opening was authorized. Any residue from the first label can then be more readily explained or interpreted if the device is ever returned again. Such a recordation or marking process can be repeated for multiple authorized device openings. In this manner, an electronic device can be serviced multiple times, with a U-label or other suitable label or indicator being used to help determine if an unauthorized opening of the device has taken place at any time in the process.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A flat and flexible label adapted for detecting whether or not a device has been opened, comprising:
a first distal end having an adhesive substance affixed to a top side thereof and adapted to be affixed to a surface of a first object;
a second distal end having an adhesive substance affixed to a bottom side thereof and adapted to be affixed to a surface of a second object separate from said first object, wherein said first and second objects are adapted to be coupled together to form a single device; and
a middle portion between said first and second distal ends, said middle portion having one or more directional changes therein such that said entire label does not lie in a straight line, wherein each of said first distal end, said second distal end and said middle portion are substantially flat and lie substantially within a single plane.

2. The label of claim 1, wherein said middle portion comprises a U-shape.

3. The label of claim 1, wherein said middle portion comprises a zigzag shape.

4. The label of claim 1, wherein said label becomes damaged when said single device is substantially opened.

5. The label of claim 4, wherein said single device becomes substantially opened when said first object is tilted with respect to said second object, with the resulting angle being greater than about 40 degrees.

6. The label of claim 4, wherein said single device becomes substantially opened when said first object is tilted with respect to said second object, with the resulting angle being greater than about 10 degrees.

7. The label of claim 4, wherein said single device becomes substantially opened when said first object and said second object are separated more than about one inch apart at any location where said first object and said second object touch to form said single device.

8. The label of claim 4, wherein said damage comprises a tear in said label.

9. The label of claim 1, wherein said label is formed from one or more materials selected from the group consisting of paper, plastic, metallic foil, and a PET film.

10. The label of claim 1, wherein said adhesive substance is formed from one or more materials selected from the group consisting of glue, cement, paste and double-sided tape

11. An electronic device, comprising:
a first housing component containing one or more internal components;
a second housing component, wherein said first and second housing components are adapted to be coupled together to form said electronic device; and
a flat and flexible label having a first distal end having an adhesive substance on a top side thereof affixing said first distal end to an internal surface associated with said first housing component, a second distal end having an adhesive substance on a bottom side thereof affixing said second distal end to an internal surface associated with said second housing component, and a middle portion between said first and second distal ends, said middle portion having one or more directional changes therein such that said entire label does not lie in a straight line, wherein each of said first distal end, said second distal end and said middle portion are substantially flat and lie substantially within a single plane.

12. The electronic device of claim 11, wherein said middle portion of said label comprises a U-shape.

13. The electronic device of claim 11, wherein said label becomes damaged when said electronic device is substantially opened.

14. The electronic device of claim 13, wherein said electronic device becomes substantially opened when said first housing component is tilted with respect to said second housing component, with the resulting angle being greater than about 40 degrees.

15. The electronic device of claim 13, wherein said electronic device becomes substantially opened when said first housing component is tilted with respect to said second housing component, with the resulting angle being greater than about 10 degrees.

16. The electronic device of claim 13, wherein said damage comprises a tear in said label.

17. The electronic device of claim 11, wherein said label is formed from one or more materials selected from the group consisting of paper, plastic, metallic foil, and a PET film.

18. A method of detecting whether an electronic device has been opened, the method comprising:
forming a first portion of an electronic device;
forming a second portion of said electronic device;
attaching a flat and flexible label to each of said first and second portions such that a substantial separation of said first and second portions from each other results in said label becoming damaged;
combining said first and second portions to form said electronic device, wherein said flat and flexible label is located entirely within said electronic device;
opening said electronic device a small amount, said small amount being an amount that would be insufficient to damage said label; and
determining whether said label is damaged.

19. The method of claim 18, wherein said flat and flexible label includes a first distal end having an adhesive substance affixed to a top side thereof, a second distal end having an adhesive substance affixed to a bottom side thereof, and a middle portion between said first and second distal ends, said middle portion having one or more directional changes therein such that said entire label does not lie in a straight line, wherein each of said first distal end, said second distal end and said middle portion are substantially flat and lie substantially within a single plane.

20. The method of claim 19, wherein attaching step includes attaching the adhesive side of said first distal end to said first portion and attaching the adhesive side of said second distal end to said second portion of said electronic device.
